(19) United States
(12) Patent Application Publication
(10) Pub. No.: US 2022/0407774 A1
(43) Pub. Date: Dec. 22, 2022

(54) METHOD AND APPARATUS FOR MODIFYING THE DEPLOYMENT OF RESOURCE ELEMENTS IN PUBLIC CLOUDS BASED ON HARVESTED PERFORMANCE METRICS

(71) Applicant: VMware, Inc., Palo Alto, CA (US)

(72) Inventors: Raghav Kempanna, Bangalore (IN); Rajagopal Sreenivasan, Bangalore (IN); Sudarshana Kandachar Sridhara Rao, Bangalore (IN); Kumara Parameshwaran, Bangalore (IN); Vipin Padmam Ramesh, Nagercoil (IN)

(21) Appl. No.: 17/569,524

(22) Filed: Jan. 6, 2022

(30) Foreign Application Priority Data
Jun. 18, 2021 (IN) 202141027333
Jun. 18, 2021 (IN) 202141027414

(51) Int. Cl. H04L 41/0813; H04L 67/10

(52) U.S. Cl. CPC H04L 41/0813; H04L 67/10

(57) ABSTRACT

Some embodiments of the invention provide a method of adjusting deployment of a set of resource elements in a public cloud. The method deploys agents on a first set of resource elements in the public cloud. The method communicates with the deployed agents to generate performance metrics regarding the first set of resource elements. The method analyzes the performance metrics to determine that a deployment of a second set of resource elements in the public cloud has to be modified. The method modifies the deployment of the second set of resource elements based on the analysis.

### BACKGROUND

Today, scaling and serving high influxes of traffic and requests is necessary in a rapidly growing world of Internet network infrastructure. Traffic patterns can vary depending on various factors such as application, time of day, region, etc., which has led to a transition to virtualization from traditional hardware appliances in order to cater to the varying traffic patterns. As public datacenters offered by multiple cloud service providers (CSPs) become more popular and widespread, virtual network functions (VNFs), and/or other types of tenant deployable elements, that were previously deployed on private datacenters are now being migrated to the CSPs, which offer various resource element types (e.g., resource elements that offer different compute, network, and storage options).

However, the performance metrics published by these CSPs are often simplistic and fall short of providing necessary information that is crucial to deployment and elasticity of the VNFs. As a result, several challenges arise including determining the appropriate resource element type to meet the performance needs of various VNFs, dimensioning the deployment (e.g., determining the number of instances of the resource element type needed and determining an availability set for fault tolerance), determining whether the published SLAs (service-level agreements) are adhered to, determining the scale-in/-out triggers for different resource element types, etc.

### BRIEF SUMMARY

Some embodiments of the invention provide a method for evaluating multiple candidate resource elements that are candidates for deploying a set of one or more tenant deployable elements in a public cloud. For each particular tenant deployable element, the method deploys in the public cloud at least one instance of each of a set of one or more candidate resource elements and at least one agent to execute on the deployed resource element instance. The method communicates with each deployed agent to collect metrics for quantifying performance of the agent's respective resource element instance. The method then aggregates the collected metrics in order to generate a report that quantifies performance of each candidate resource element in the set of candidate resource elements for deploying the particular tenant deployable element in the public cloud.

In some embodiments, the generated reports are used for each particular tenant deployable element to select a candidate resource element to use to deploy the particular tenant deployable element in the public cloud. Also, in some embodiments, first and second types of candidate resource elements are candidates for one particular tenant deployable element, and by quantifying the performance of the first and second candidate resource elements, the report specifies either the first or second candidate resource element as a better resource element for deploying the particular tenant deployable element than the other candidate resource element. In addition to selecting which candidate resource element to deploy, some embodiments also use the generated report to determine a number of instances of the candidate resource element to deploy for the particular tenant deployable element in the public cloud. In some embodiments, to deploy the candidate resource element instance(s), a resource element instance is selected from a pool of pre-allocated resource elements in the public cloud, while in other embodiments, one or more new instances of the resource element are spun up for deployment.

The candidate resource elements, in some embodiments, also include different sub-types of candidate resource elements. In some embodiments, these different sub-types perform a same set of operations for the tenant deployable resource, but consume different amounts of resources on host computers, such as processor resources, memory resources, storage resources, and ingress/egress bandwidth. For example, in some embodiments, the tenant deployable element is a workload or service machine for execution on a host computer, and the different sub-types of candidate resource elements perform a set of operations of the workload or service machine, but consume different amounts of memory. The selected candidate resource element, in some embodiments, is selected based on whether these amounts meet a guaranteed SLA, or whether the number of instances of the selected candidate resource elements it takes to meet the SLA based on these amounts is fewer than the number of instances of other candidate resource elements it takes to meet the SLA. Alternatively, or conjunctively, different resource elements of the same resource element type, in some embodiments, perform different sets of operations.

The collected metrics, in some embodiments, include metrics such as throughput (e.g., in bits per second, in bytes per second, etc.), packets per second, connections per second, requests per second, transactions per second, transmission controller protocol (TCP) SYN arrival rate, number of open TCP connections, number of established TCP connections, and number of secure socket layer (SSL) transactions. In some embodiments, the metrics are collected based on a set of variables (e.g., variables specified in a request) such as cloud service provider (CSP) (e.g., Amazon AWS, Microsoft Azure, etc.), region, availability zone, resource element type, time of day, payload size, payload type, and encryption and authentication types. For example, the metrics in some embodiments may be collected for a particular resource element type in a public cloud provided by a particular CSP in a particular region during a particular time of day (e.g., during peak business hours for the particular region).

In some embodiments, the resource element types include compute resource elements (e.g., virtual machines (VMs), containers, middlebox service, nodes, and pods), networking resource elements (e.g., switches, routers, firewalls, load balancers, and network address translators (NATs)), and storage resource elements (e.g., databases, datastores, etc.). Examples of tenant deployable elements, in some embodiments, include load balancers, firewalls, intrusion detection systems, deep packet inspectors (DPIs), and network address translators (NATs).

In some embodiments, a controller or controller cluster directs each deployed agent to perform a set of performance-related tests on the agent's respective resource element instance to collect metrics associated with the agent's respective resource element instance. The controller cluster, in some embodiments, also configures each deployed agent to provide the collected metrics to the controller cluster, which aggregates the collected metrics to generate the report. In some embodiments, the controller cluster configures the agents to provide the collected metrics to the controller cluster by recording the metrics in a database accessible to the controller cluster so that the controller cluster can retrieve the metrics from the database for aggregation. In some such embodiments, the controller cluster stores the generated report in the database, and retrieves the generated report (and other reports) from the database in order to respond to requests for metrics, and requests to identify and deploy additional resource element instances in the public cloud and in other public clouds, according to some embodiments.

Also, in some embodiments, the controller cluster monitors the deployed resource elements and modifies these deployed resource elements based on evaluations of both real-time (i.e., current) and historical metrics. In some embodiments, the controller cluster modifies the deployed resource elements by scaling-up or scaling-down the number of instances of the deployed resource element. For example, the controller cluster scales-up or scales-down the number of instances periodically, in some embodiments, to ensure a guaranteed SLA is met during normal hours and during peak hours (i.e., by scaling-up the number of instances during peak hours, and scaling back down the number of instances during normal hours).

The controller cluster, in some embodiments, operates in the same public cloud as the agents, while in other embodiments, the controller cluster operates in another cloud (public or private). When the controller cluster operates in another cloud, in some embodiments, at least one agent is deployed in the other cloud and communicates with each other agent deployed in the public cloud to perform at least one performance-related test for which both agents (i.e., the agent in the public cloud and the agent in the other cloud) collect metric data.

In some embodiments, the deployed agents and the controller cluster implement a framework for evaluating a set of one or more public clouds and one or more resource elements in the set of public clouds as candidates for deploying tenant deployable elements. The requests, in some embodiments, are received from users through a user interface provided by the controller cluster. Alternatively, or conjunctively, the requests in some embodiments are received from network elements through a representational state transfer (REST) endpoint provided by the controller cluster.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, the Detailed Description, the Drawings, and the Claims is needed. Moreover, the claimed subject matters are not to be limited by the illustrative details in the Summary, the Detailed Description, and the Drawings.

### BRIEF DESCRIPTION OF FIGURES

The novel features of the invention are set forth in the appended claims. However, for purposes of explanation, several embodiments of the invention are set forth in the following figures.

FIG. 1 conceptually illustrates a data gathering framework deployed in a virtual network in some embodiments.

FIG. 2 illustrates a simplified diagram showing a performance traffic stream, in some embodiments.

FIG. 3 illustrates a process performed by the controller and orchestrator, in some embodiments, to collect performance metrics.

FIG. 4 illustrates a process performed by the controller in some embodiments to respond to a query for performance information.

FIG. 5 illustrates a virtual network in which the data gathering framework is deployed during a set of performance-related tests, in some embodiments.

FIG. 6 illustrates a process performed in some embodiments to improve network performance based on real-time and historical performance metrics.

FIG. 7 illustrates a process performed in some embodiments in response to a request to identify and deploy a resource in a public cloud for implementing a tenant deployable element.

FIG. 8 illustrates a process of some embodiments for modifying a resource element deployed in a public cloud datacenter based on a subset of performance metrics associated with the resource element and the public cloud datacenter.

FIG. 9 illustrates a process for evaluating multiple candidate resource elements that are candidates for deploying a set of one more tenant deployable elements in a public cloud, according to some embodiments.

FIG. 10 illustrates a process of some embodiments for deploying resource elements in response to a request to implement a particular tenant deployable element in either a first public cloud datacenter or a second public cloud datacenter.

FIG. 11 illustrates a series of stages of some embodiments as a data gathering and measurement framework performs tests to select a public cloud from a set of public clouds provided by different CSPs for deploying a resource element.

FIG. 12 illustrates a series of stages as a data gathering and measurement framework performs tests to select a resource element type from a set of resource element types for deployment in a cloud datacenter, according to some embodiments.

FIG. 13 illustrates a process for selecting a candidate resource element to deploy in a public cloud to implement a tenant deployable element, according to some embodiments.

FIG. 14 conceptually illustrates a computer system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments of the invention provide a method for evaluating multiple candidate resource elements that are candidates for deploying a set of one or more tenant deployable elements in a public cloud. For each particular tenant deployable element, the method deploys in the public cloud at least one instance of each of a set of one or more candidate resource elements and at least one agent to execute on the deployed resource element instance. The method communicates with each deployed agent to collect metrics for quantifying performance of the agent's respective resource element instance. The method then aggregates the collected metrics in order to generate a report that quantifies performance of each candidate resource element in the set of candidate resource elements for deploying the particular tenant deployable element in the public cloud.

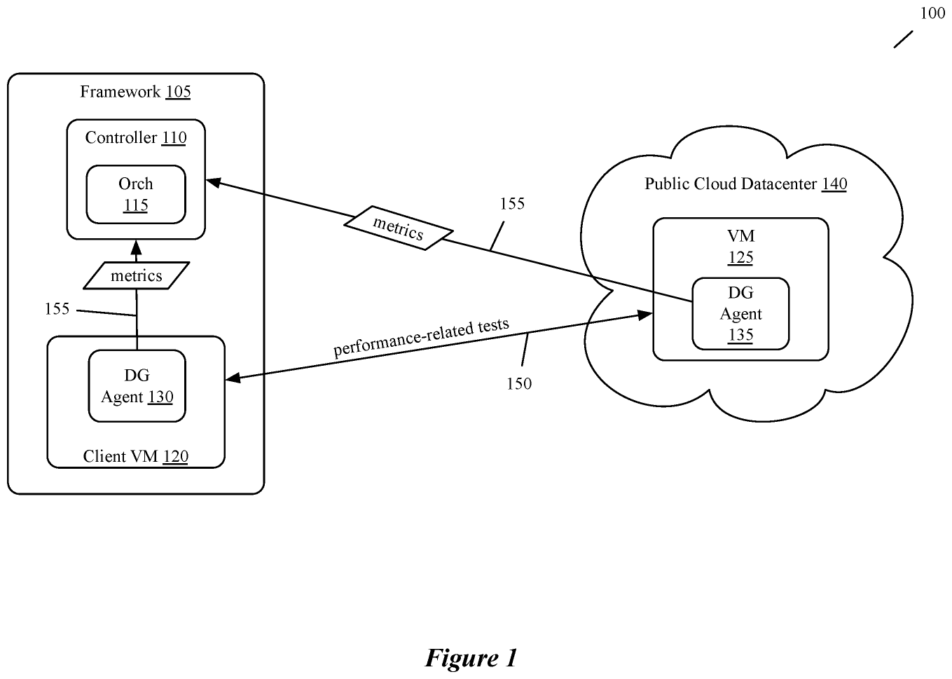

FIG. 1 illustrates a data gathering framework deployed in a virtual network in some embodiments to collect metrics across multiple public CSPs, regions, resource element types, times of day, payload types, and payload sizes, which are used to obtain real-time and historical performance metrics. In some embodiments, the framework can be realized as a software as a service (SaaS) application that offers services where information can be made available via a user interface (UI), REST APIs, and reports, while in other embodiments, the framework can be realized as an independent standalone companion application that can be deployed both alongside and bundled within a tenant deployable element, such as a virtual network function (VNF) or a cloud-native network function. Examples of tenant deployable elements in some embodiments include deep packet inspectors (DPIs), firewalls, load balancers, intrusion detection systems (IDSs), network address translators (NATs), etc.

As illustrated, the virtual network 100 includes a controller 110 (or controller cluster) and a client resource 120 within the framework 105, and a virtual machine (VM) 125 within the public datacenter 140. The client resource 120 can be a client-controlled VM operating in the framework 105. While the controller and the client resource 120 are visually represented together within the framework 105, the controller and client resource in some embodiments are located at different sites. For example, the controller 110 in some embodiments may be located at a first private datacenter, while the client resource 120 is located at a second private datacenter.

The virtual network 100 in some embodiments is established for a particular entity. An example of an entity for which such a virtual network can be established includes a business entity (e.g., a corporation), a non-profit entity (e.g., a hospital, a research organization, etc.), and an education entity (e.g., a university, a college, etc.), or any other type of entity. Examples of public cloud providers include Amazon Web Services (AWS), Google Cloud Platform (GCP), Microsoft Azure, etc., while examples of entities include a company (e.g., corporation, partnership, etc.), an organization (e.g., a school, a non-profit, a government entity, etc.), etc. In some embodiments, the virtual network 100 is a Software-Defined Wide Area Network (SDWAN) that span multiple different public cloud datacenters in different geographic locations.

The client resource 120 and the VM 125 in some embodiments can be resource elements of any resource element type and include various combinations of CPU (central processing unit), memory, storage, and networking capacity. While the client resource elements 120 and the VM 125 are illustrated and described herein as instances of VMs, in other embodiments, these resource can be containers, pods, compute nodes, and other types of VMs (e.g., service VMs). As shown, the client resource 120 include a data gathering (“DG”) agent 130 and the VM 125 includes a DG agent 135 (a DG agents is also referred to herein as a “agent”).

Additionally, the controller 110 includes an orchestration component 115. In some embodiments, the client resource 120, the VM 125, and the agents 130 and 135 are deployed by the orchestration component 115 of the controller 110 for the purpose of performing performance-related tests and collecting performance metrics (e.g., key performance indicators (KPIs)) during those tests. Also, in some embodiments, the orchestration component may deploy additional resource elements of a same resource element type, or different resource element type(s), in the public cloud datacenter 140, as well as in other public cloud datacenters (not shown), as will be further described below.

In some embodiments, the agents 130 and 135 perform individual tests at their respective sites, and perform tests between the sites along the connection links 150. Different performance-related tests can be used to measure different metrics, in some embodiments. Examples of different metrics that can be measured using the performance-related tests include throughput (e.g., in bits per second, bytes per second, etc.), packets per second, connections per second, requests per second, transactions per second, TCP SYN arrival rate, number of open TCP connections, number of established TCP connections, and secure sockets layer (SSL) transactions. In some embodiments, performance metrics other than those indicated herein may also be collected. Also, in some embodiments, different metric types can be collected for different types of resource elements. For instance, the metrics collected for a load balancer may be different by one or more metric types than the metrics collected for a DPI.

As the agents 130 and 135 perform the tests and collect metrics, they send the collected metrics to the controller 110 for aggregation and analysis, in some embodiments. In the network 100, the agents 130 and 135 are illustrated with links 155 leading back to the controller 110 along which the metrics are sent. While illustrated as individual connection links, the links 150 and 155 are sets of multiple connection links, with paths across these multiple connection links, in some embodiments.

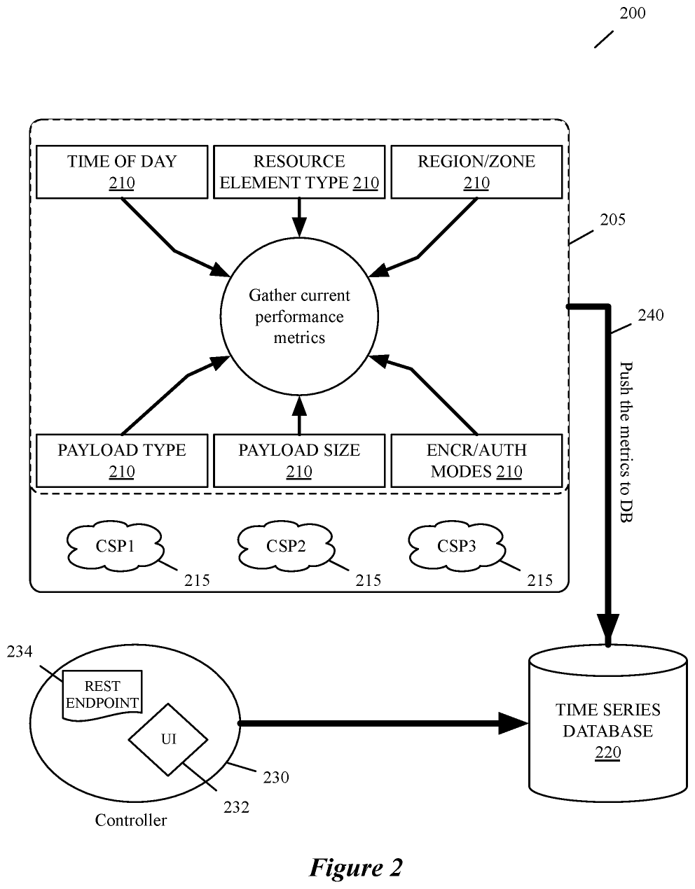

In some embodiments, rather than sending the metrics directly to the controller, the agents push the collected metrics to a time-series database where the metrics are recorded and accessed by the controller for aggregation and publication. FIG. 2 illustrates a simplified diagram showing such a performance traffic stream, in some embodiments. The traffic stream 200 includes a public cloud datacenter 205 in which performance metrics 210 are gathered from a set of CSPs 215, a time-series database 220, and a controller 230 that includes a user interface (UI) 232 and a REST endpoint 234.

As illustrated, the collected metrics include time of day, resource element type, region/zone, payload type, payload size, and encryption/authentication modes. In some embodiments, the collected metrics can include additional or fewer metrics than those shown, as well as different metrics than those shown. As the metrics are gathered in the public cloud datacenter 205, they are pushed to the time-series database 220 along the path 240, and recorded in the database.

Once the collected metrics have been recorded in the time-series database 220, the controller 230 can access the collected metrics to aggregate them, and record the aggregated metrics in the database. In some embodiments, the REST endpoint 234 of the controller 230 provides a front end for publishing information, and serves published REST APIs. Additionally, the UI 232 provides a way for users to query information and receive query results, as well as to subscribe and receive standard and/or custom alerts, according to some embodiments. In some embodiments, the information from the database is used for capacity planning, dimensioning, and defining scale-in/scale-out, especially during peak hours in order to efficiently manage both the load and resource elements.

In some embodiments, the queries can be directed toward specific metrics (e.g., time of day, resource element type, region/zone, payload type, payload size, and encryption/authentication modes). For example, a query might seek to determine the packets per second from a first resource element type belonging to a first CSP in a first region to a second resource element type of a second CSP in a second region during a specified time period (e.g., 8:00 AM to 11:00 AM). Additional query examples can include a query to determine the average connections per second for a particular resource element type during a specific month of the year, and a query to determine variance in throughput on a specific day of the week for a resource element instance that claims a particular speed.

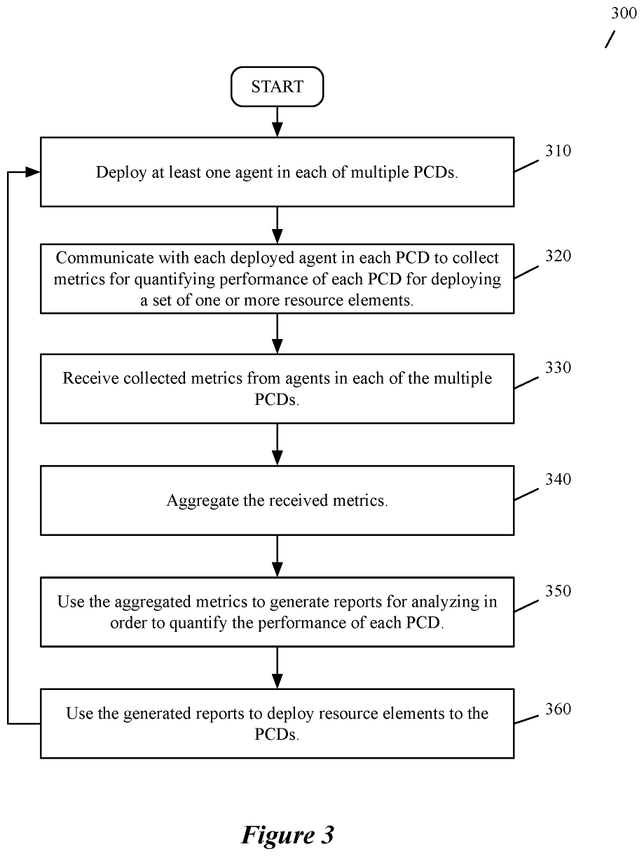

FIG. 3 illustrates a process 300 for evaluating multiple public cloud datacenters that are candidate datacenters for deploying resource elements, in some embodiments. In some embodiments, the process 300 is performed by the controller 110 to identify a public cloud for deploying one or more resource elements based on performance metrics associated with each candidate public cloud and collected by DG agents deployed in each candidate public cloud. The candidate public clouds in some embodiments include public clouds that are provided by different CSPs.

The process 300 starts (at 310) by deploying at least one agent in each of multiple public cloud datacenters (PCDs). The controller in some embodiments deploys the agents in each PCD to execute on resource elements in each PCD. In some embodiments, the controller executes in a particular cloud datacenter, and deploys at least one agent to execute within that same particular cloud datacenter. The controller, agents, and resource elements on which the agents are deployed make up a data gathering and measurement framework.

The process communicates (at 320) with each deployed agent in each PCD to collect metrics for quantifying performance of each PCD for deploying a set of one or more resource elements. For example, the controller 110 in some embodiments communicates with the deployed agents in each PCD in order to direct the deployed agents to perform one or more performance-related tests and to collect metrics associated with the performance-related tests. In some embodiments, the controller also directs the at least one agent deployed within the same particular cloud datacenter as the controller to communicate with each other agent deployed in each other PCD to perform one or more performance-related tests to quantify performance of each PCD.

The process receives (at 330) collected metrics from the agents in each of the multiple PCDs. For example, in addition to performing performance-related tests and collecting metrics to quantify the performance of the PCDs and/or resource elements in the PCDs, each agent in some embodiments is configured to provide the collected metrics to the controller. As described above with reference to the traffic stream 200, the agents in some embodiments provide the collected metrics to the controller by recording the metrics in a time-series database for retrieval by the controller.

The process then aggregates (at 340) the collected metrics received from the deployed agents. The collected metrics, in some embodiments, are associated with the PCDs as well as resource elements deployed in the PCDs. For example, in some embodiments, the agents are deployed on different resource elements in the different PCDs, and collect metrics to quantify the performance of the different resource elements in the different PCDs, in addition to collecting metrics to quantify the performance of the different PCDs. In some embodiments, each deployed agent communicates with at least one other agent within the agent's respective PCD, and at least one other agent external to the agent's respective PCD, in order to collect metrics both inside and outside of the agent's respective PCD. The controller in some embodiments aggregates the collected metrics based on PCD association and/or resource element type association.

The process uses (at 350) the aggregated metrics in order to generate reports for analyzing in order to quantify the performance of each PCD. In some embodiments, the controller 230 stores the generated reports in the time-series database 220. The controller retrieves the generated reports from the time-series database in some embodiments for use in responding to queries for metrics associated with PCDs, resource elements, and/or a combination of PCDs and resource elements. The queries, in some embodiments, are received from users through the UI 232, or from network elements (e.g., other tenant deployable elements) through the REST endpoint 234.

The process then uses (at 360) the generated reports to deploy resource elements to the PCDs. In some embodiments, the process uses the generated reports to deploy resource elements to the PCDs according to requests to identify and deploy resource elements. Like the queries for metrics, the requests to identify and deploy resource elements to the PCDs can be received by the controller from users through a UI or from tenant deployable elements through a REST endpoint. Following 360, the process returns to 310 to continue deploying agents in different PCDs to continue collecting metrics.

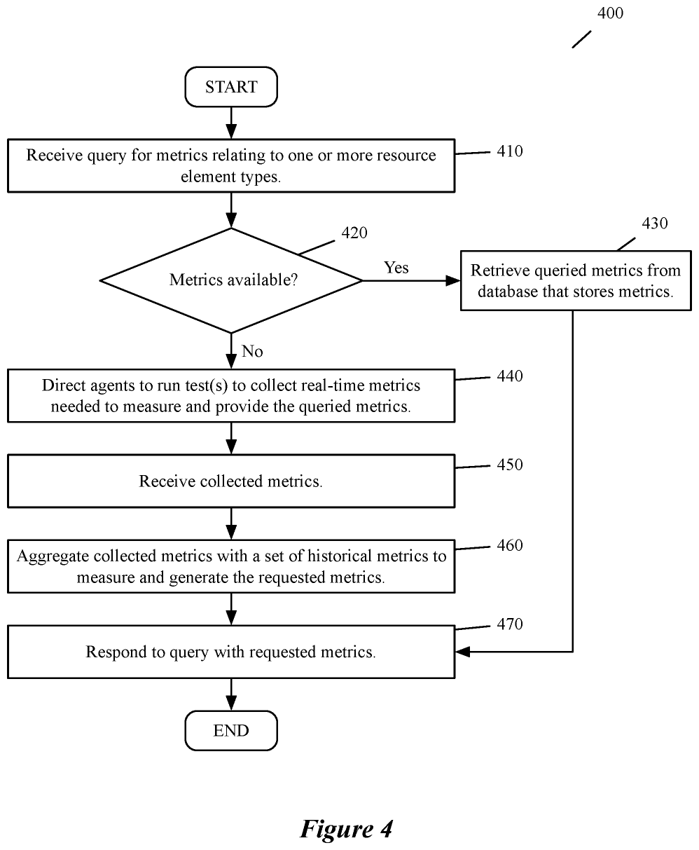

FIG. 4 illustrates a process performed by the controller in some embodiments to respond to a query for performance information. The process 400 starts at 410 when the controller receives a query for information relating to one or more resource element types. In some embodiments, the controller receives queries through either a REST endpoint or a UI, as illustrated in FIG. 2. The controller then determines, at 420, whether the queried information is available. For example, the controller in some embodiments checks the time-series database to determine if metrics for a particular resource element type referenced in the query are available.

When the controller determines at 420 that the information being queried is available, the process transitions to 430 to retrieve the queried information. The process then proceeds to 470. Otherwise, when the controller determines that the queried information is not available, the process transitions to 440 to direct agents to run tests to collect real-time metrics (i.e., current metrics) needed to measure and provide the queried information.

Next, the controller receives, at 450, the collected metrics. For example, the controller in some embodiments can retrieve the metrics from the database after the agents have pushed said metrics to the database. The controller then aggregates, at 460, the collected metrics with a set of historical metrics (e.g., also retrieved from the database) to measure and generate the requested information. For instance, the controller may aggregate the collected metrics with historical metrics associated with the same or similar resource element types.

After generating the requested information, the controller responds to the query at 470 with the requested information. When the source of the query is a tenant deployable element (e.g., a VNF or cloud-native network function), for example, the controller can respond via the REST endpoint. Alternatively, when the source of the query is a user, the controller can respond via the UI, according to some embodiments. The process 400 then ends.

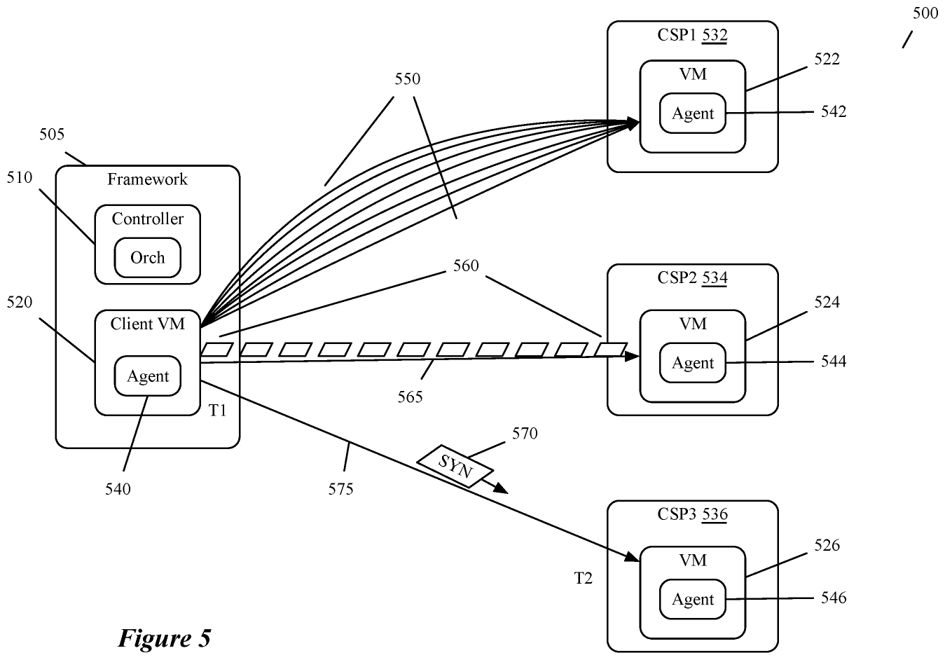

FIG. 5 illustrates a virtual network 500 in which the data gathering and measurement framework is deployed during a set of performance-related tests, in some embodiments. The virtual network 500 includes a controller (or controller cluster) 510 and a client resource element 520 within the framework 505, and VMs 522, 524, and 526 in public clouds 532, 534, and 536, respectively. Additionally, data gathering agents 540, 542, 544, and 546 are deployed on the client resource element 520, the VM 542, the VM 544, and the VM 546, respectively.

The figure illustrates three different performance-related tests being performed by the framework 505. In a first test, the client resource element 520 has several connections 550 to the VM 522, and the framework determines the number of connections that the VM can handle per second. In performing this test, the client resource element 520 continues to send connection requests to the VM 522, in some embodiments, until the VM becomes overloaded. In some embodiments, this test is performed multiple times according to multiple different sets of parameters, and, as a result, can be used to calculate, e.g., the average number of connections per second a particular VM can handle (e.g., a threshold number of connections per second). As will be discussed further below, different types of resource elements can include different sub-types of the resource elements which consume different amounts of resources (e.g., host computer resources), in some embodiments. In some such embodiments, the different sub-types may be associated with different metrics.

In a second test between the client resource element 520 and the VM 524, multiple packets 560 are sent along the connection link 565. The framework in turn determines the number of packets per second that the link 565 or the VM 524 can handle. The client resource element 520 can continue to send multiple packets to the VM 524 until the VM becomes overloaded (e.g., when packets begin to drop). Like the first test, the framework can perform this second test according to different sets of parameters (e.g., for different resource element types, different regions, different time periods, etc.).

In a third test between the client resource element 520 and the VM 526, the client resource element is illustrated as sending a SYN message 570 to the VM 526 along the connection link 575. Timestamps T1 and T2 are shown on either end of the connection link 575 to represent the sent and received times of the SYN message, and are used to determine the SYN arrival rate.

As the agents 540-546 collect the metrics from these tests, the agents push the collected metrics to the controller (i.e., to the database) for aggregation. In some embodiments, each of the tests illustrated is performed for each of the VMs. Also, in some embodiments, the tests can be performed between the different VMs of the various CSPs to measure performance between CSPs.

In some embodiments, the controller 110 manages resource elements deployed in public cloud datacenters based on real-time and historical performance metrics associated with the resource elements. In some embodiments, the controller monitors a particular resource element deployed in a particular public cloud datacenter (PCD). The controller identifies a set of performance metric values that correspond to a specified subset of performance metric types that are associated with the particular resource element and the particular PCD (e.g., CPU usage by a VM running in the PCD). The controller evaluates the identified set of performance metric values based on a set of guaranteed performance metric values, and modifies the particular resource element based on the evaluation (e.g., by deploying additional resource element instances of the particular resource element.)

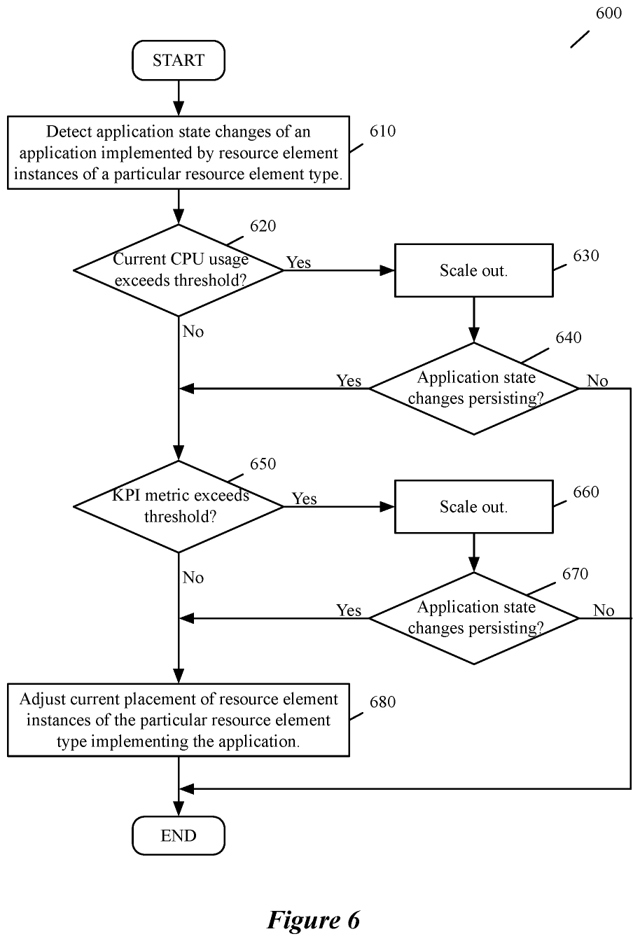

FIG. 6 illustrates a process performed in some embodiments to improve the performance of a virtual network based on real-time and historical performance metrics. The process 600 starts, at 610 by detecting application state changes. In some embodiments, the detected state changes are due to an application experiencing an unexpected period of downtime (e.g., due to network outages, server failures, etc.). After detecting the state changes, the process determines, at 610, whether the current CPU usage by the resource element (e.g., VM, container, etc.) executing the application exceeds a threshold.

The current CPU usage in some embodiments is the current CPU usage by the resource element as reported in a cloud environment. In some embodiments, the detected application state changes are a result of CPU usage by the resource element exceeding a threshold. To make this determination, some embodiments compare current (i.e., real-time) CPU usage of the resource element with historical or baseline CPU usage for the resource element to identify anomalies/discrepancies in the current CPU usage.

When the process determines at 620 that the CPU usage of the resource element does not exceed the threshold, the process transitions to 650 to determine whether one or more characteristic metrics associated with the resource element exceed a threshold. Otherwise, when the process determines at 620 that the CPU usage of the resource element does exceed the threshold, the process transitions to 630 to scale-out the number of instances of the resource element deployed in the cloud environment (i.e., to help distribute the load). In some embodiments, the process scales-out the number of instances by spinning up additional instances of the resource element to deploy. Alternatively, or conjunctively, some embodiments select additional resource element instances from a pre-allocated pool of resource element instances. The process then transitions to 640 to determine whether the application state changes are persisting.

When the process determines at 640 that the application state changes are no longer persisting (i.e., scaling out the number of instances of the resource element has resolved the issue), the process ends. Otherwise, when the process determines at 640 that the application state changes are still persisting, the process transitions to 650 to determine whether one or more characteristic metrics of the resource element (e.g., time of day, resource element type, region/zone, payload type, payload size, and encryption/authentication modes) exceed a threshold. In some embodiments, the detected state change is due to exceeding a threshold associated with one or more key performance metrics specific to the traffic pattern being served by a particular instance of a resource element. For example, the controller in some embodiments can determine that a guaranteed SLA is not being met by a particular resource element type, and in turn, provide additional instances of that type of resource element in order to meet the guaranteed SLA.

When the process determines at 650 that no characteristic metrics exceed the threshold, the process transitions to 680 to adjust the resource element instance's current placement. Otherwise, when the process determines at 650 that one or more characteristic metrics have exceeded the threshold, the process transitions to 660 to scale-out the number of resource element instances. The process then determines, at 670, whether the application state changes are still persisting (i.e., despite the additional resource element instances). When the process determines at 670 that the state changes are no longer persisting, the process ends.

Alternatively, when the process determines at 670 that the state changes are persisting, the process transitions to 680 to adjust the current placement of the resource element instance(s). Some embodiments, for example, change a resource element instance's association from one host to another host (e.g., to mitigate connection issues experienced by the former host). Alternatively, or conjunctively, some embodiments adjust the placement of the resource element instance from one public cloud datacenter to another public cloud datacenter. As another alternative, some embodiments upgrade the resource element instance to a larger resource element instance on the same public cloud datacenter. After the resource element instance's current placement is adjusted at 680, the process ends.

In addition to responding to queries for different metrics and reports, the data gathering framework of some embodiments also receives and responds to queries directed to identifying resource element types for implementing tenant deployable elements and identifying public cloud datacenters in which instances of the identified resource element types should be deployed. For example, a query in some embodiments can include a request to identify a resource element type from a set of resource element types for deployment in one of two or more public cloud datacenters of two or more different CSPs. In some embodiments, the request specifies a set of criteria for identifying the resource element type and selecting the public cloud datacenter (e.g., the resource element type must be able to handle N number of connection requests per second).

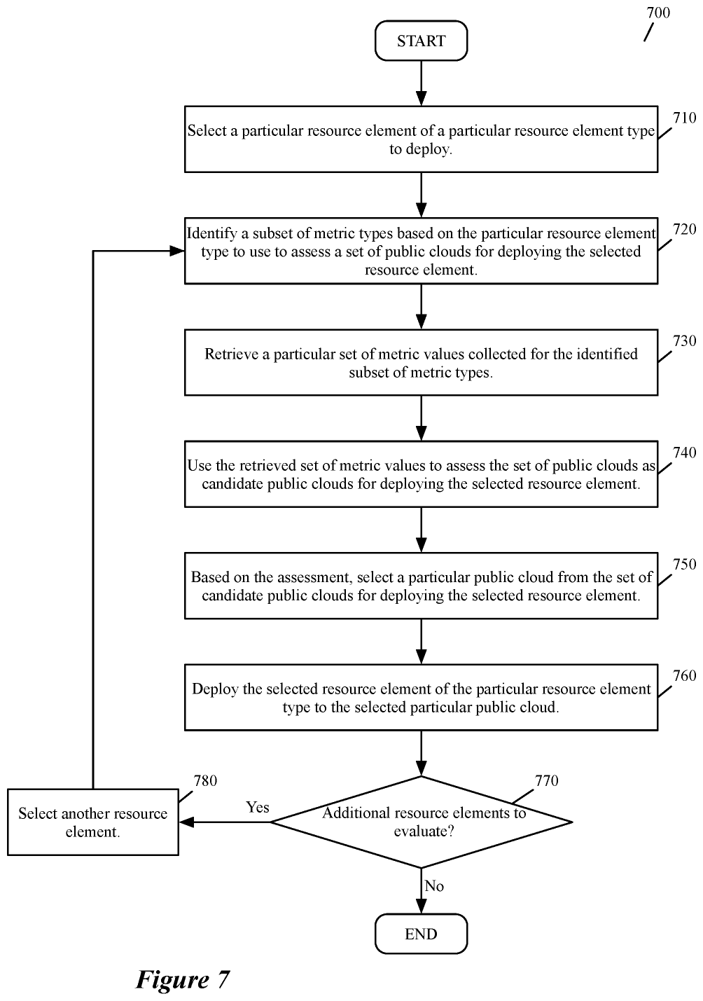

FIG. 7 illustrates a process 700 for deploying resource elements to a set of public clouds. In some embodiments, the process 700 is performed by the controller 110 to select a public cloud for deploying a selected resource element. The set of public clouds may include public clouds that are provided by different CSPs, in some embodiments.

The process 700 starts when the controller receives a request to deploy a resource element. The process selects (at 710) a particular resource element of a particular resource element type to deploy. In some embodiments, the process identifies the particular resource element of the particular resource element type to deploy by identifying a resource element type for implementing a particular tenant deployable element. Such a tenant deployable element in some embodiments may be a load balancer, a firewall, an intrusion detection system (IDS), a deep packet inspector (DPI), and network address translator (NAT).

The process identifies (at 720) a subset of metric types based on the particular resource element type to use to assess a set of public clouds for deploying the first resource element. In some embodiments, the subset of metric types is specified in the request to deploy the particular resource element, while in other embodiments, the process identifies from available or possible metric types a subset of metric types that are relevant to the particular resource element type as the subset of metric types.

The process retrieves (at 730) a particular set of metric values collected for the identified subset of metric types. In some embodiments, the metric values are retrieved by having one or more agents (e.g., the agents 540-546) perform the process 300 to collect the metrics or metric values associated with the particular resource element type. Alternatively, some embodiments retrieve the metric values from a database. The metric values collected by the agents, in some embodiments, include throughput (e.g., in bits per second, in bytes per second, etc.), packets per second, connections per second, requests per second, transactions per second, transmission control protocol (TCP) SYN arrival rate, number of open TCP connections, and number of established TCP connections.

The process uses the retrieved metric values to assess (at 740) the set of public clouds as candidate public clouds for deploying the selected resource element. In some embodiments, each candidate public cloud is assessed based on its own set of metric values for the identified subset of metric types for the particular resource element type (i.e., metric values collected for both the particular resource element type and the candidate public cloud). For example, in the virtual network 500 described above, the metrics collected by the agents 542-546 can include metrics associated with each VM 522-526 and their respective public clouds 532-536, in some embodiments.

Based on the assessment, the process selects (at 750) a particular public cloud from the set of public clouds for deploying the selected resource element. In some embodiments, the candidate public cloud having the best set of metric values for the identified subset of metric types for the selected resource element type compared to other candidate public clouds is selected. Alternatively, or conjunctively, the controller cluster in some embodiments provides the metrics to a user (e.g., network administrator) through a UI in the form of a report, and receives a selection through the UI from the user. In some embodiments, the selection includes an identifier for the selected public cloud.

The process deploys (at 760) the selected resource element of the particular resource element type to the selected particular public cloud. In some embodiments, the deployed particular resource element is a resource element instance selected from a pool of pre-allocated resource element instances of the particular resource element type in the selected public cloud. Alternatively, or conjunctively, some embodiments spin up new instances of the resource element for deployment.

The process then determines (at 770) whether there are any additional resource elements to evaluate for deployment. When the process determines that there are additional resource elements to evaluate, the process transitions to 780 to select another resource element. In some embodiments, the additional resource element selected for evaluation is a second resource element of a second resource element type. After selecting the second resource element, the process returns to 720 to identify a subset of metric types based on the second resource element. The subset of metric types identified for the second resource element may differ from the subset of metric types identified for the other resource element of the other type by at least one metric type, according to some embodiments. Additionally, in some embodiments, the second resource element performs different functions than the other resource element, while in other embodiments, the resource elements perform the same functions. In some embodiments, a second particular public cloud that is provided by a different CSP than the particular public cloud selected for the other resource element is then selected from the set of public clouds for deploying the second resource element of the second resource element type.

Returning to process 700, when the process instead determines (at 770) that there are no additional resource elements to evaluate, the process 700 ends. The data gathering and measurement framework described herein has many use cases, several of which are described above. To elaborate further on these novel use cases, and provide other novel use cases, additional novel processes for using the data gathering and measurement framework to intelligently deploy resources, and scale these resources, in a public cloud will be described below.

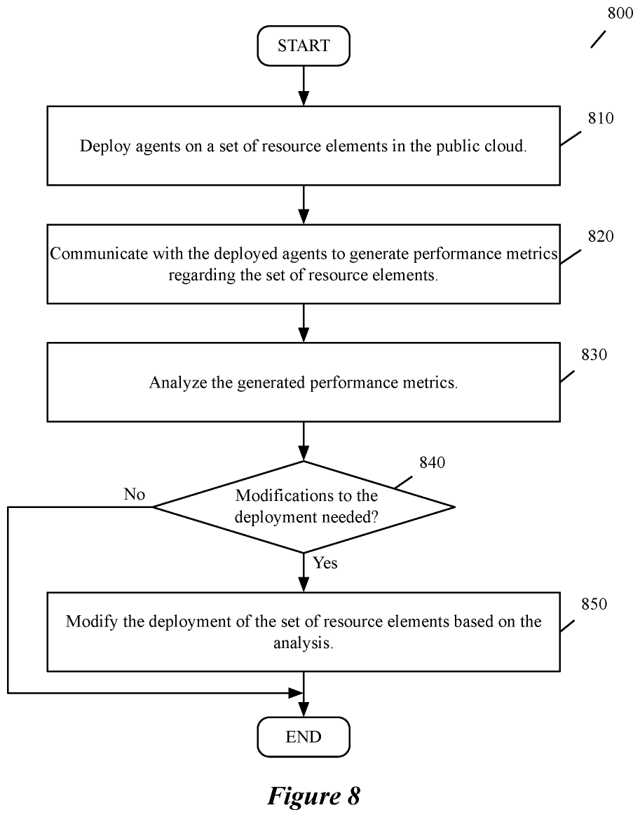

FIG. 8 illustrates a process of some embodiments for modifying resource elements deployed in a public cloud based on a subset of performance metrics associated with the resource elements and the public cloud. In some embodiments, the process 800 is performed by a controller or controller cluster (e.g., the controller 230) that is part of the data gathering and measurement framework. The process 800 starts by deploying (at 810) agents on a set of resource elements in the public cloud. In some embodiments, the set of resource elements implement a tenant deployable resource in the public cloud, such as a firewalls, load balancers, intrusion detection systems, DPIs, or NATs.

The resource elements, in some embodiments, are a second set of resource elements that is identical to a first set of resource elements that already exist in the public cloud. In some embodiments, the controller cluster deploys the second set of resource elements to collect metrics and use the metrics to test the environment (i.e., public cloud environment) and modify the first set of resource elements accordingly. For example, in some embodiments, the first and second sets of resource elements are first and second sets of machines that are similarly configured (i.e., the second set of machines are configured like the first set of machines) deployed on the same or similar host computers in the public cloud. In other embodiments, the resource elements are existing resource elements that are actively serving a particular tenant.

The process communicates (at 820) with the deployed agents to generate performance metrics regarding the set of resource elements. For example, in some embodiments, the controller cluster directs the agents to perform a set of performance-related tests in order to generate the performance metrics. In some embodiments, the controller cluster instructs the agents to perform specific tests to generate specific types of metrics (e.g., based on the type of resource elements in the set), while in other embodiments, the controller cluster instructs the agents to perform a set of default performance tests intended to capture a wide variety of metrics.

As described above, the agents perform the performance-related tests, in some embodiments, by communicating with other agents in other cloud datacenters. In some embodiments, the agents communicate with each other by sending data messages and collecting operational metrics related to the sent, and/or received, data messages. When the resource elements are the second set of resource elements corresponding to the existing first set of resource elements, in some embodiments, the data messages used in the performance tests are data messages similar to those sent and/or received by the existing first set of resource elements. In some embodiments, the data messages are sent to, and received from, other elements both inside of, and external to, the public cloud in which the resource elements are deployed.

The process then analyzes (at 830) the generated performance metrics. Each deployed resource element, in some embodiments, is associated with a guaranteed SLA, and the controller cluster, or a set of designated servers, analyzes the generated performance metrics by comparing guaranteed performance metric values specified by the SLA for the set of resource elements with the generated performance metrics to determine whether the guaranteed performance metric values are being met by the particular resource element. Alternatively, or conjunctively, the controller cluster in some embodiments analyzes the generated performance metrics by comparing them with historical performance metrics retrieved from a database (e.g., database 232) and associated with the set of resource elements and/or associated with other resource elements of the same type to identify fluctuations or changes in performance.

Based on the analysis, the process determines (at 840) whether any modifications to the deployment of the set of resource elements are needed. In some embodiments, for example, the controller cluster may determine that the performance of the set of resource elements has degraded, improved, or remained consistent when compared to historical performance metrics from the database. Similarly, the controller cluster in some embodiments may determine that the performance of the set of resource elements meets, does not meet, or exceeds a guaranteed SLA.

When the process determines (at 840) that no modifications to the deployment of the set of resource elements are needed (i.e., the analysis did not indicate performance issues), the process ends. Otherwise, when the process determines that modifications to the set of resource elements are needed, the process transitions to 850 to modify the deployment of the set of resources based on the analysis. As described above for the process 700, the set of resource elements can be modified by scaling out the number of instances of the resource elements in the set, in some embodiments, and/or by adjusting the placement of the particular resource element (e.g., by placing the particular resource element on another host). In some embodiments, the process 800 modifies the particular resource element by removing the particular resource element and replacing it with a different resource element. The different resource element, in some embodiments, is of a different resource element type, or a different resource element sub-type. Following 850, the process 800 ends.

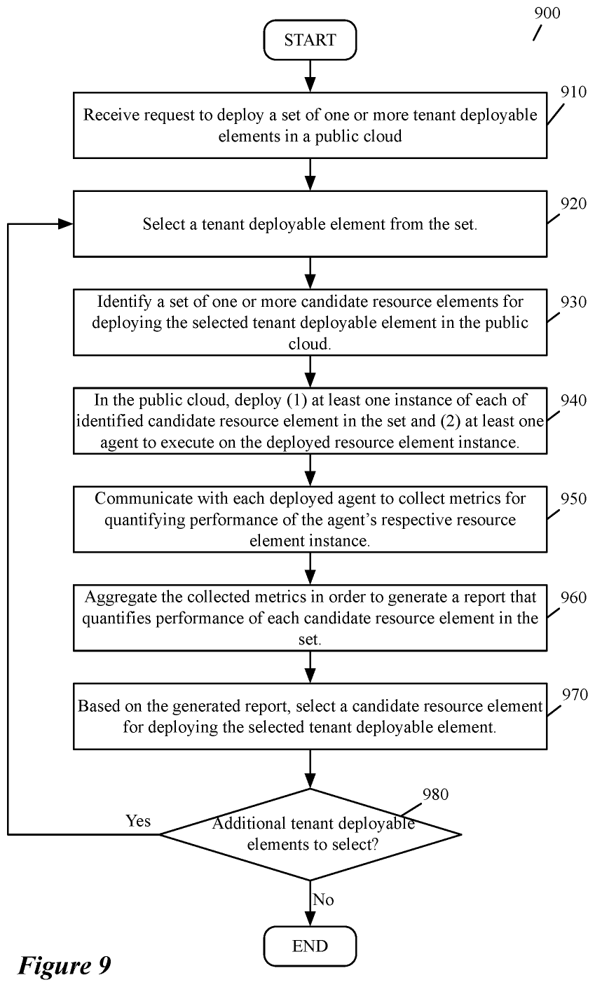

FIG. 9 illustrates a process for evaluating multiple candidate resource elements that are candidates for deploying a set of one more tenant deployable elements in a public cloud, according to some embodiments. In some embodiments, the process 900 is performed by a controller or controller cluster that is part of the data gathering and measurement framework. The process 900 starts by receiving (at 910) a request to deploy a set of one or more tenant deployable elements in a public cloud. The request in some embodiments can be received from a user through a UI provided by the controller cluster, or from a network element, in some embodiments, through a REST endpoint provided by the controller cluster.

The process then selects (at 920) a tenant deployable element from the set, and identifies (at 930) a set of one or more candidate resource elements for deploying the selected tenant deployable element in the public cloud. The candidate resource elements, in some embodiments, include different types of resource elements that are candidates for deploying the selected tenant deployable element. Examples of candidate resource elements of some embodiments include compute resource elements (e.g., virtual machines (VMs), containers, middlebox service, nodes, and pods), networking resource elements (e.g., switches, routers, firewalls, load balancers, and network address translators (NATs)), and storage resource elements (e.g., databases, datastores, etc.).

In some embodiments, the different types of candidate resource elements also include different sub-types of candidate resource elements. For example, the set of candidate resource elements for the selected tenant deployable element can include first and second candidate resource elements that are of the same type, and that perform the same set of operations of the selected tenant deployable element, but are considered different sub-types due to differences in the amounts of resources they consume (i.e., resources of the host computers on which they are deployed in the public cloud). These host-computer-resources in some embodiments include compute resources, memory resources, and storage resources.

In the public cloud, the process deploys (at 940) at least one instance of each of identified candidate resource element in the set and at least one agent to execute on the deployed resource element instance. The deployed agents, in some embodiments, are configured to run performance-related tests on their respective candidate resource elements in order to generate and collect performance-related metrics. In some embodiments, at least one agent is deployed in another cloud (e.g., a private cloud datacenter of the tenant) to allow for cross-cloud performance tests, such as testing the connections per second of a particular candidate resource element. The at least one agent in the other cloud is deployed in the same cloud as the controller cluster, in some embodiments.

The process communicates (at 950) with each deployed agent to collect metrics for quantifying performance of the agent's respective resource element instance. In some embodiments, communicating with the deployed agents includes configuring the agents to perform the tests mentioned above, and to provide metrics collected in associated with these test to the controller cluster. The agents of some embodiments are configured to provide the collected metrics to the controller cluster by recording the metrics to a database accessible to the controller cluster (e.g., as described above for FIG. 2).

The process aggregates (at 960) the collected metrics in order to generate a report that quantifies performance of the agent's respective resource element instance. As described above, the collected metrics, in some embodiments, include metrics such as throughput (e.g., in bits per second, in bytes per second, etc.), packets per second, connections per second, requests per second, transactions per second, transmission controller protocol (TCP) SYN arrival rate, number of open TCP connections, number of established TCP connections, and number of secure socket layer (SSL) transactions. In some embodiments, the controller cluster stores the generated report in a database for later use.

Based on the generated report, the process selects (at 970) a candidate resource element from the set for deploying the selected tenant deployable element. In some embodiments, the controller cluster selects the candidate resource element based on criteria specified in the request to deploy the set of tenant deployable elements, or based on which candidate resource element is the best fit for meeting a guaranteed SLA. The selection, in some embodiments, also includes determining a number of instances of the candidate resource element to deploy for the selected tenant deployable element. Alternatively, or conjunctively, the controller cluster in some embodiments provides the generated report to a user (e.g., to network administrator through the UI) to allow the user to select which candidate resource element to deploy. In some such embodiments, the controller cluster may provide recommendations in the report as to which candidate resource element should be selected.

The process determines (at 980) whether there are any additional tenant deployable elements in the set to select. When the process determines that there are additional tenant deployable elements to select (i.e., for evaluating candidate resource elements for deploying the tenant deployable elements), the process returns to 920 to select a tenant deployable element from the set. Otherwise, when the process determines (at 980) that there are no additional tenant deployable resources in the set to select the process ends.

In some embodiments, rather than, or in addition to evaluating multiple candidate resource elements that are candidates for deploying multiple tenant deployable elements, the controller cluster performs the process 900 to evaluate multiple candidate resource elements for deploying a single tenant deployable element in a single public cloud.

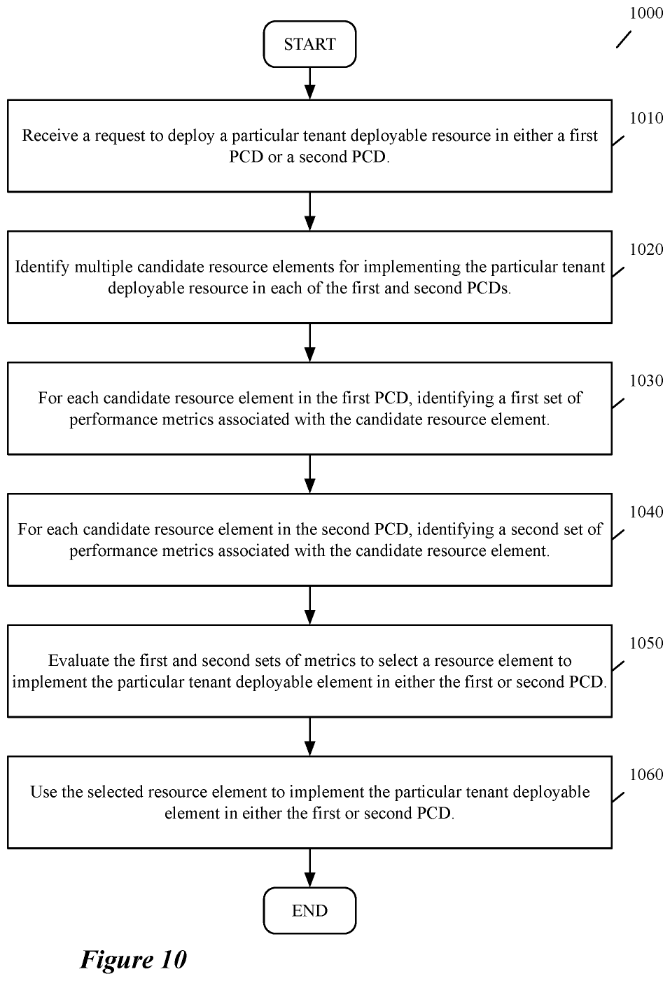

FIG. 10 illustrates a process of some embodiments for deploying resource elements in response to a request to implement a particular tenant deployable element in either a first public cloud datacenter or a second public cloud datacenter. The process 1000 starts by receiving (at 1010) a request to deploy a particular tenant deployable element in either a first public cloud datacenter or a second public cloud datacenter. As described above, examples of tenant deployable elements in some embodiments include load balancers, firewalls, intrusion detection systems, DPIs, and NATs.

The process identifies (at 1020) multiple candidate resource elements for implementing the particular tenant deployable element in each of the first and second public cloud datacenters. Multiple candidate resource elements exist in each of the first and second public cloud datacenters for the particular tenant deployable element, according to some embodiments, while in other embodiments, only one candidate resource element exists in either one, or both, of the datacenters. In some embodiments, the particular tenant deployable element is a VNF and all of the candidate resource elements are VMs. Alternatively, in some embodiments, the particular tenant deployable element is a cloud-native network function and the candidate resource elements are containers.

For each candidate resource element in the first public cloud datacenter, the process identifies (at 1030) a first set of performance metrics associated with the candidate resource element. For each candidate resource element in the second public cloud datacenter, the process identifies (at 1040) a second set of performance metrics associated with the candidate resource element. The performance metrics associated with the candidate resource elements, in some embodiments, are retrieved by the controller cluster from a database (e.g., the database 232).

In some embodiments, a particular candidate resource element that exists in both the first and second public cloud datacenters may be referred to differently within each public cloud datacenter. In some such embodiments, the controller cluster may include a mapping between the different names of the particular candidate resource element in order to ensure the correct metrics are retrieved. Also, in some embodiments, such as when no performance metrics associated with one or more of the candidate resources are stored in the database, or when the stored metrics do not include current metrics, the controller cluster performs the process 300 to collect performance metrics for each candidate resource element for which no performance metrics are stored.

The process evaluates (at 1050) the first and second sets of metrics to select a candidate resource element to implement the particular tenant deployable element in either the first or second public cloud datacenter. In some embodiments, the controller makes this selection based on which candidate resource element/public cloud datacenter combination has the best overall metrics, while in other embodiments, the controller makes this selection based on which candidate resource element/public cloud datacenter combination has the best metrics compared to a set of desired metrics or other criteria provided with the request to implement the particular tenant deployable resource. The specified criteria, in some embodiments, can include performance criteria (e.g., a specified threshold value or range for a particular performance metric), non-performance criteria (e.g., CSP identifier, region identifier, availability zone identifier, resource element type, time of day, payload size, payload type, and encryption and authentication types), or a combination of both performance and non-performance criteria.

The process then uses (at 1060) the selected resource element to implement the particular tenant deployable element in either the first or second public cloud datacenter. The process then ends. In some embodiments, rather than making the selection itself as part of an automated process, the controller cluster generates a report identifying the performance metrics associated with the candidate resource elements and provides the report to a user (e.g., to a network administrator through a UI) to enable the user to manually make a selection. The controller cluster in some embodiments may provide recommendations in the report as to which candidate resource element should be selected. In some such embodiments, the controller cluster receives an identifier of the user-selected resource element through the UI.

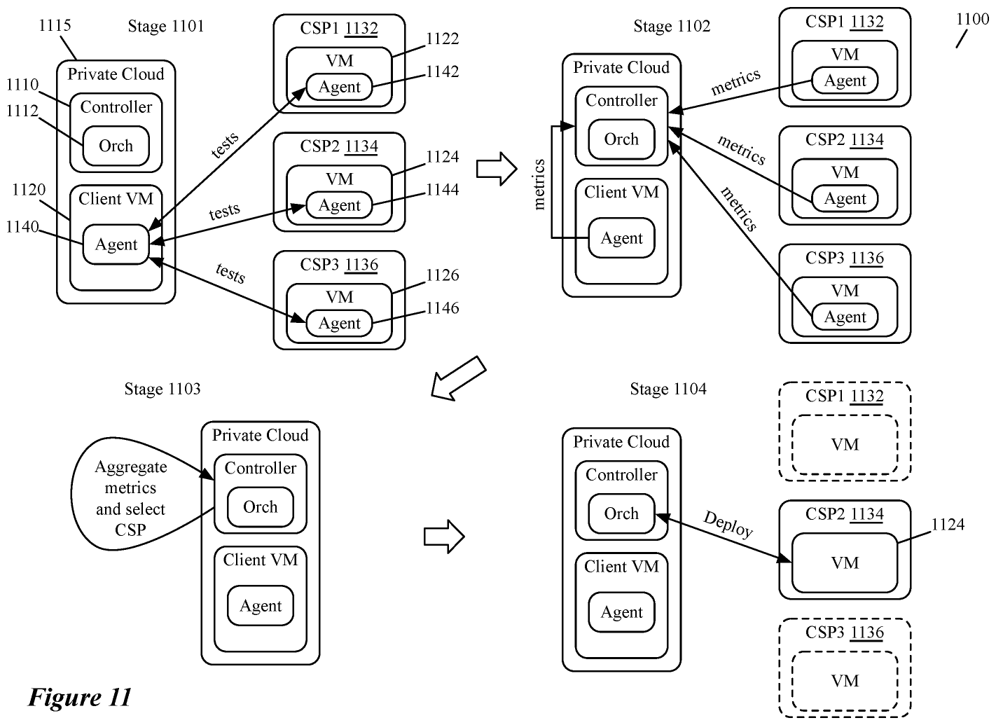

FIG. 11 illustrates a series of stages 1100 as a data gathering and measurement framework performs tests to select a public cloud from a set of public clouds provided by different CSPs for deploying a resource element. In the first stage 1101, an agent 1140 on a client VM 1120 executing in a private cloud 1115 communicates with a set of agents deployed on instances of a VM in three different cloud datacenters provided by three different CSPs in order to run performance-related tests to measure the performance of the VM in each of the different cloud datacenters. As shown, the set of agents on the VM instances in the different cloud datacenters include agent 1142 on VM instance 1122 in cloud datacenter 1132, agent 1144 on VM instance 1124 in cloud datacenter 1134, and agent 1146 on VM instance 1126 in cloud datacenter 1136. The different cloud datacenters 1132-1136 are public cloud datacenters, in some embodiments, while in other embodiments, they are private cloud datacenters or a mix of public and private cloud datacenters.

In the second stage 1102, each of the agents 1140-1146 are shown providing metrics (i.e., performance metrics collected by the agents during the test in stage 1101) to the controller 1110. While not shown, the agents in some embodiments provide the metrics to the controller by recording the metrics in a database accessible to the controller, as also described in some of the embodiments above. Also, while illustrated as being co-located in the same private cloud 1115, the controller 1110 and the client VM 1120 in other embodiments execute in different locations (e.g., different clouds, different datacenters, etc.). In still other embodiments, the controller 1110 executes in one of the cloud datacenters 1132-1136. Additionally, while this example illustrates VM instances being deployed, other embodiments can include other types of resource elements, such as containers and pods.

Next, the controller aggregates the received metrics in stage 1103 in order to select one of the cloud datacenters provided by one of the CSPs for deploying the VM (i.e., resource element). Finally, in stage 1104, the orchestration component 1112 of the controller 1110 deploys the VM instance 1124 in the selected cloud datacenter 1134, while the remaining cloud datacenters are illustrated with dotted lines to indicate they were not selected for deploying the VM instance.

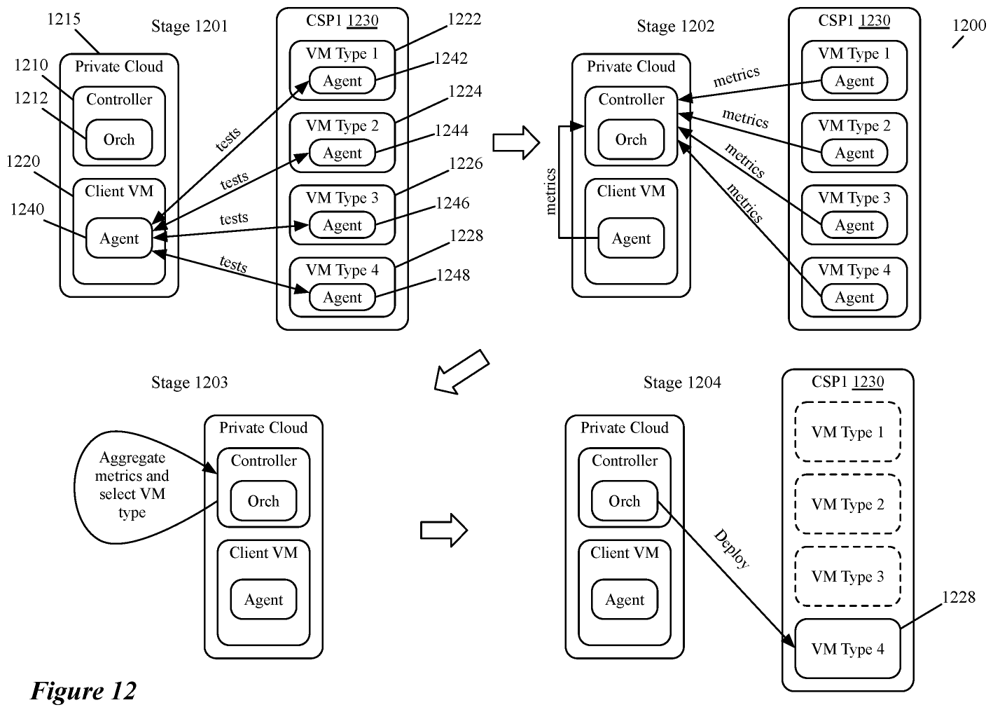

Similar to FIG. 11, FIG. 12 illustrates a series of stages 1200 as a data gathering and measurement framework performs tests to select a resource element type from a set of resource element types for deployment in a cloud datacenter 1230. In the first stage 1201, an agent 1240 on a client VM 1220 in a private cloud 1215 is shown communicating with four agents each executing on a VM instance of a different type in a datacenter 1230 provided by a particular CSP. For example, the agent 1240 is shown communicating with an agent 1242 on a VM instance of a first type 1222, an agent 1244 on a VM instance of a second type 1224, an agent 1246 on a VM instance of a third type 1226, and an agent 1248 on a VM instance of a fourth type 1228.

The resource element types in some embodiments include a variety of resource element types, while in other embodiments, the resource element types are resource element sub-types defined by an amount of resources consumed by the resource element (i.e., resources of the host computer on which the resource element executes). Examples of consumable resources include processing resources, storage resources, and memory resources, according to some embodiments. Accordingly, while the resource element instance types described in this example are illustrated and described as sub-types of VMs (i.e., VMs that consume different amounts of host-computer-resources), other embodiments include sub-types of other resource element types (e.g., sub-types of containers), while still other embodiments include a variety of different resource element types and resource element sub-types (e.g., a combination of VM instance sub-types and container instance sub-types).

In some embodiments, the resource element types depend on the type of tenant deployable element that the resource elements are implementing, and/or the types of operations performed by the tenant deployable element. For example, the tenant deployable element can be a workload or service machine, a forwarding element that has to be deployed on a machine executing on a host computer or deployed as a forwarding appliance, or a middlebox service element.

In the second stage 1202, each of the agents 1240-1248 are shown providing metrics (i.e., metrics collected during the tests in stage 1201) to the controller 1210 in the private cloud 1215. As described above for FIG. 11, the agents in some embodiments provide the metrics to the controller by recording the metrics to a database accessible to the controller. Also, while the controller is illustrated as executing in the private cloud 1215, the controller in other embodiments can be located in other clouds or datacenters, including the cloud datacenter 1230, in some embodiments.

In the next stage 1203, the controller aggregates the metrics received from the agents in order to select a VM type to deploy in the cloud datacenter 1230. In some embodiments, the controller aggregates the metrics and generates a report identifying the selected VM type and stores the report in the database for later use (e.g., to respond to queries for metrics). Also, in some embodiments, the controller provides the aggregated metrics to users through a UI (e.g., the UI 232 of the controller 200 described above) in response to users subscribing to receive metrics and reports.

In the final stage 1204, the orchestration component 1212 of the controller 1210 deploys a VM instance 1228 of the selected VM type 4 in the cloud datacenter 1230, while the other VM types are illustrated with dashed outlines to indicate these types were not selected for deployment. While only one instance of the VM 1228 is shown, multiple instances of the selected VM type are deployed in some embodiments.

As mentioned above for FIG. 7, some embodiments use the data gathering and measurement framework to evaluate different types of resource elements. For instance, to evaluate different types of resource elements when trying to deploy a web server, some embodiments use the framework to assess different sub-types of web servers to be deployed. In some embodiments, the different sub-types are defined by the amount of resources consumed (i.e., resources of the host computer on which the resource element operates). Higher priority resource elements are allocated more resources to consume, in some embodiments, while lower priority resource elements are allocated fewer resources to consume.

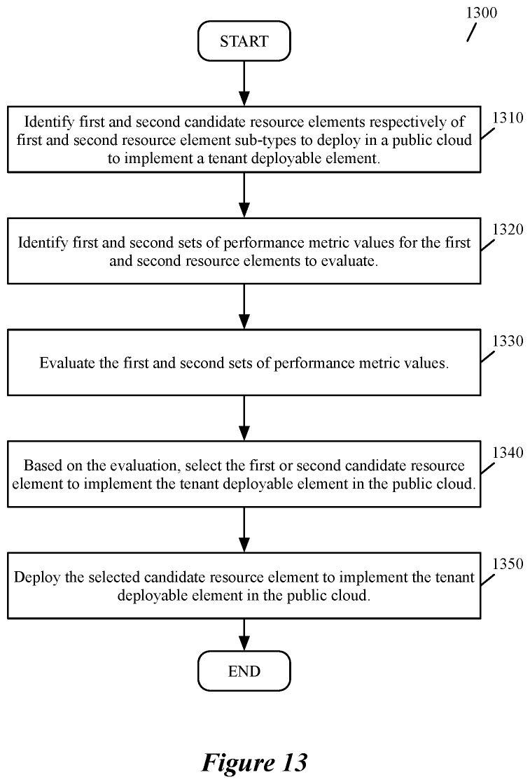

FIG. 13 illustrates a process for selecting a candidate resource element of a particular sub-type to deploy in a public cloud to implement a tenant deployable element, according to some embodiments. The process 1300 is performed in some embodiments by a controller, controller cluster, or set of servers. The process 1300 starts by identifying (at 1310) first and second candidate resource elements respectively of first and second resource element sub-types to deploy in a public cloud to implement a tenant deployable element. The first and second candidate resource element sub-types are resource elements of the same type, but that consume different amount of resources on the host computer on which they execute. For example, the candidate resource elements in some embodiments are two VMs that consume different amounts of processing resources of the host computer.

The process identifies (at 1320) first and second sets of performance metric values for the first and second resource elements to evaluate. The first and second sets of performance metric values, in some embodiments, are metric values of the same metric types and are retrieved from a database by the controller cluster. In some embodiments, the controller cluster performs the process 900 in order to collect metric values for the candidate resource elements when there are no metric values associated with the candidate resource elements in the database.

The process evaluates (at 1330) the first and second sets of performance metric values. In some embodiments, the controller evaluates the first and second sets of performance metric values by comparing them to each other. Also, in some embodiments, the controller cluster compares the sets of performance metric values with a guaranteed SLA, or other criteria (e.g., other criteria specified in a request to deploy the tenant deployable element).

Based on this evaluation, the process selects (at 1340) the first or second candidate resource element to implement the tenant deployable element in the public cloud. The selected candidate resource element, in some embodiments, is the candidate resource element having the closest performance metrics to those specified in the guaranteed SLA, while in other embodiments, the selected candidate resource element is the candidate resource element that best matches the criteria specified in the request. In still other embodiments, the selected candidate resource element is the candidate resource element with the overall best performance metric values. Also, in some embodiments, the controller cluster provides the evaluated performance metrics to a user in the form of a report through a UI to enable the user to make the selection. The report, in some embodiments, includes a suggestion for which candidate resource element should be selected. In some embodiments, the controller cluster receives an identifier of the user-selected candidate resource element through the UI. The process then deploys (at 1350) the selected candidate resource element to implement the tenant deployable element in the public cloud. Following 1350, the process ends.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

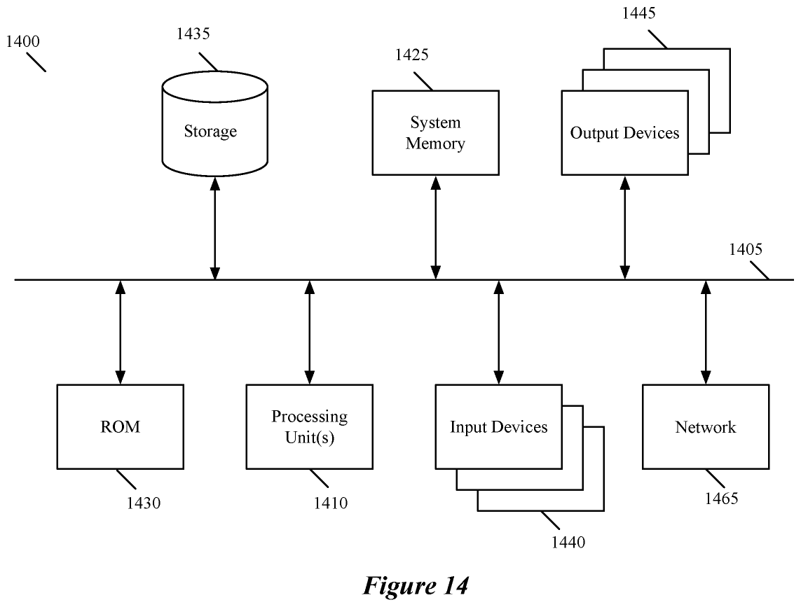

FIG. 14 conceptually illustrates a computer system 1400 with which some embodiments of the invention are implemented. The computer system 1400 can be used to implement any of the above-described hosts, controllers, gateway and edge forwarding elements. As such, it can be used to execute any of the above described processes. This computer system includes various types of non-transitory machine readable media and interfaces for various other types of machine readable media. Computer system 1400 includes a bus 1405, processing unit(s) 1410, a system memory 1425, a read-only memory 1430, a permanent storage device 1435, input devices 1440, and output devices 1445.

The bus 1405 collectively represents all system, peripheral, and chipset buses that communicatively connect the numerous internal devices of the computer system 1400. For instance, the bus 1405 communicatively connects the processing unit(s) 1410 with the read-only memory 1430, the system memory 1425, and the permanent storage device 1435.

From these various memory units, the processing unit(s) 1410 retrieve instructions to execute and data to process in order to execute the processes of the invention. The processing unit(s) may be a single processor or a multi-core processor in different embodiments. The read-only-memory (ROM) 1430 stores static data and instructions that are needed by the processing unit(s) 1410 and other modules of the computer system. The permanent storage device 1435, on the other hand, is a read-and-write memory device. This device is a non-volatile memory unit that stores instructions and data even when the computer system 1400 is off. Some embodiments of the invention use a mass-storage device (such as a magnetic or optical disk and its corresponding disk drive) as the permanent storage device 1435.

Other embodiments use a removable storage device (such as a floppy disk, flash drive, etc.) as the permanent storage device. Like the permanent storage device 1435, the system memory 1425 is a read-and-write memory device. However, unlike storage device 1435, the system memory is a volatile read-and-write memory, such as random access memory. The system memory stores some of the instructions and data that the processor needs at runtime. In some embodiments, the invention's processes are stored in the system memory 1425, the permanent storage device 1435, and/or the read-only memory 1430. From these various memory units, the processing unit(s) 1410 retrieve instructions to execute and data to process in order to execute the processes of some embodiments.

The bus 1405 also connects to the input and output devices 1440 and 1445. The input devices enable the user to communicate information and select commands to the computer system. The input devices 1440 include alphanumeric keyboards and pointing devices (also called “cursor control devices”). The output devices 1445 display images generated by the computer system. The output devices include printers and display devices, such as cathode ray tubes (CRT) or liquid crystal displays (LCD). Some embodiments include devices such as touchscreens that function as both input and output devices.

Finally, as shown in FIG. 14, bus 1405 also couples computer system 1400 to a network 1465 through a network adapter (not shown). In this manner, the computer can be a part of a network of computers (such as a local area network (“LAN”), a wide area network (“WAN”), or an Intranet), or a network of networks (such as the Internet). Any or all components of computer system 1400 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself

As used in this specification, the terms “computer”, “server”, “processor”, and “memory” all refer to electronic or other technological devices. These terms exclude people or groups of people. For the purposes of the specification, the terms “display” or “displaying” mean displaying on an electronic device. As used in this specification, the terms “computer readable medium,” “computer readable media,” and “machine readable medium” are entirely restricted to tangible, physical objects that store information in a form that is readable by a computer. These terms exclude any wireless signals, wired download signals, and any other ephemeral or transitory signals.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

1. A method of adjusting deployment of a set of resource elements in a public cloud, the method comprising:
deploying agents on a first set of resource elements in the public cloud;
communicating with the deployed agents to generate performance metrics regarding the first set of resource elements;
analyzing the performance metrics to determine that a deployment of a second set of resource elements in the public cloud has to be modified, wherein the first and second sets of resource elements are different sets of resource elements; and
modifying the deployment of the second set of resource elements based on the analysis.

2. (canceled)

3. The method of claim 1, wherein the agents are deployed on the first set of resource elements that are different from than the second set of resource elements that are subsequently modified based on the analysis of metrics collected through the deployed agents on the first set of resource elements.

4. The method of claim 3, wherein the first and second sets of resource elements are first and second sets of machines that are deployed on the same host computers in a datacenter, the first set of machines being deployed to test the performance of an environment in which the second set of machines operate.

5. The method of claim 4, wherein each machine in the first set of machines is similarly configured to a machine in the second set of machines.

6. The method of claim 4, wherein communicating with the deployed agents comprises sending data messages to the first set of machines similar to data message sent to the second set of machines.

7. The method of claim 1, wherein the first and second sets of resource elements are first and second sets of machines and communicating with the deployed agents comprises sending data messages to the first set of machines and collecting operational metrics related to the sent data messages.

8. The method of claim 7, wherein the collected operational metrics related to the sent data messages comprise operational metrics collected by the deployed agents and sent to a set of servers for evaluation.

9. The method of claim 7, wherein collecting operational metrics related to the sent data messages comprise collecting operational metrics from responsive messages that the first set of machines send back in response to the sent data messages.

10. The method of claim 9 further comprising sending to a set of servers the operational metrics collected from the responsive data messages, wherein the set of servers analyze the sent operational metrics.

11. The method of claim 1, wherein modifying the deployment of the second set of resource elements comprises adjusting amount of one or more resources allocated to the second set of resource elements on a set of host computers on which the second set of resource elements execute.

12. The method of claim 1, wherein modifying the deployment of the second set of resource elements comprises adding a resource element to the second set.

13. The method of claim 1, wherein modifying the deployment of the second set of resource elements comprises removing a resource element from the second set.

14. The method of claim 1, wherein said communicating, analyzing and modifying are performed by a performance monitoring framework that monitors performances of resources in public cloud datacenters.

15. The method of claim 1, wherein the communicating, analyzing and modifying comprises using a set of one or more machines deployed outside of the public cloud to communicate with the first set of resources, analyze performance metrics collected through the communication and direct the modification of the second set of resources.

16. A non-transitory machine readable medium storing a program for execution by a set of processing units, the program for adjusting deployment of a set of resource elements in a public cloud, the program comprising sets of instructions for:
deploying agents on a first set of resource elements in the public cloud;
communicating with the deployed agents to generate performance metrics regarding the first set of resource elements;
analyzing the performance metrics to determine that a deployment of a second set of resource elements in the public cloud has to be modified, wherein the first and second sets of resource elements are different sets of resource elements; and
modifying the deployment of the second set of resource elements based on the analysis.

17. (canceled)

18. The non-transitory machine readable medium of claim 16, wherein the agents are deployed on the first set of resource elements that are different from than the second set of resource elements that are subsequently modified based on the analysis of metrics collected through the deployed agents on the first set of resource elements.

19. The non-transitory machine readable medium of claim 16, wherein the set of instructions for communicating with the deployed agents comprises a set of instructions for sending data messages to the first set of resource elements and collecting operational metrics from responsive messages that the first set of resource elements send back in response to the sent data messages.

20. The non-transitory machine readable medium of claim 19 further comprising a set of instructions for sending to a set of servers the operational metrics collected from the responsive data messages, wherein the set of servers analyze the sent operational metrics.

21. The method of claim 3, wherein each of the deployed agents are directed to perform a set of performance-related tests on the agent's respective resource element in the first set of network elements to collect metrics associated with the agent's respective resource element instance

22. The method of claim 6, wherein the deployed agents collect operational metrics based on the data messages sent to the first set of machines.
